(19) United States
(12) Patent Application Publication
(10) Pub. No.: US 2015/0134351 A1
(43) Pub. Date: May 14, 2015

(54) HEALTHCARE INFORMATION SYSTEMS AND METHODS

(71) Applicant: Anthony Mari, Marietta, GA (US)

(72) Inventor: Anthony Mari, Marietta, GA (US)

(21) Appl. No.: 14/537,655

(22) Filed: Nov. 10, 2014

Related U.S. Application Data
(60) Provisional application No. 61/901,902, filed on Nov. 8, 2013.

(51) Int. Cl. G06F 19/00

(52) U.S. Cl. CPC G06F 19/3418; G06F 19/322
USPC 705/2

(57) ABSTRACT

A healthcare information system, according to various embodiments is configured to provide a unified healthcare information system from which: (1) a user can view medical information associated with themselves and with one or more members of their family; (2) a medical professional can provide medical information to the user; and (3) users who share various medical issues can connect with one another. The medical information available to the users may include, for example, medical records, test results, etc. The medical professionals may, for example, provide treatment follow up information and similar information via the system. In some embodiments, connected users may provide support or encouragement to one another when dealing with similar ailments.

### CROSS REFERENCE TO RELATED APPLICATION

This application claims the benefit of priority to U.S. Provisional Patent Application No. 61/901,902, filed Nov. 8, 2013, entitled, “Healthcare Information Systems and Methods,” which is incorporated herein by reference in its entirety.

### BACKGROUND

Individuals may desire to have better access to their medical records and other medical information about themselves and about family members. Some individuals may also desire to have easier methods of interacting with medical professionals. Accordingly there is a need for improved systems and methods that address these needs.

### SUMMARY

A computer-implemented method, in various embodiments, comprises: (1) providing, by a processor, to a user, a patient interface for enabling the user to access a unified healthcare information system; (2) receiving, by a processor, a first request, from the user via the patient interface, to view healthcare information associated with a person selected from a group consisting of: (i) the user; and (ii) one or more people associated with the user. In various embodiments, the computer implemented method further comprises: (1) at least partially in response to receiving the first request, retrieving, by a processor, the health information and displaying the health information to the user; (2) providing, by a processor, to a healthcare practitioner, a healthcare practitioner dashboard for sending one or more alerts to the user; (3) receiving, by a processor, a second request from a healthcare practitioner via the healthcare practitioner dashboard to provide one or more alerts to the user based at least in part on one or more rules; (4) at least partially in response to receiving the second request, determining, by a processor whether the user falls under the one or more rules; and (5) at least partially in response to determining that the user falls under the one or more rules, substantially automatically sending a push notification, by a processor, to the user that comprises the one or more alerts.

A computer-implemented method of facilitating healthcare communication, in various embodiments, comprises: (1) receiving, by a processor, a first request from a first user to view medical information associated with the first user, the medical information including medical information associated with at least one medical condition; (2) at least partially in response to receiving the first request, providing, by a processor, the medical information to the first user; (3) receiving, by a processor, a second request from the first user to connect with at least one person having at least one shared medical condition; (4) at least partially in response to receiving the second request, determining, by a processor, at least one second user having the at least one shared medical condition; (5) at least partially in response to determining the at least one second user, enabling two way communication between the first user and the second user.

A non-transitory computer-readable medium, according to particular embodiments, stores computer executable instructions for: (1) providing a patient interface for enabling the user to access a unified healthcare information system to a first user; (2) providing a healthcare practitioner dashboard for sending one or more alerts to the first user to at least one healthcare practitioner; (3) providing a patient connection interface for connecting one or more patients to the first user; (4) receiving, from the first user via the patient interface, a first request to retrieve medical information associated with the first user; (5) at least partially in response to receiving the first request, displaying the medical information to the first user; (6) receiving, from the at least one healthcare professional via the healthcare practitioner dashboard, a second request to send an alert to the first user; (7) at least partially in response to receiving the second request, sending the alert to the first user; (8) receiving, from the first user via the patient connection interface, a third request to connect the first user with at least one second user sharing at least one medical condition with the first user; (9) at least partially in response to receiving the third request, determining at least one second user who shares at least one medical condition with the first user; and (10) at least partially in response to determining the at least one second user, facilitating two way communication between the first user and the at least one second user.

### BRIEF DESCRIPTION OF THE DRAWINGS

Various embodiments of a system and method for collecting, tracking, and storing performance and system information for computing devices are described below. In the course of this description, reference will be made to the accompanying drawings, which are not necessarily drawn to scale, and wherein:

FIG. 1 is a block diagram of a computing device diagnostic system in accordance with an embodiment of the present system;

FIG. 2 is a schematic diagram of a computer, such as the healthcare information server of FIG. 1, that is suitable for use in various embodiments;

FIG. 3 depicts a flow chart that generally illustrates various steps executed by a Healthcare Information Module that, for example, may be executed by the healthcare information server of FIG. 1;

FIGS. 4-12 are exemplary screen displays of the system according to various embodiments.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In various embodiments, a healthcare information system may include a centralized dashboard of healthcare information for a particular group (e.g., a family) from which a member of the group may access healthcare information (e.g., such as medical records), documents (e.g., ID cards, birth certificates, passports, etc.) and other information related to the group members. In particular embodiments, the system may further include a healthcare practitioner dashboard and may be further configured to enable one or more healthcare practitioners to send one or more alerts to one or more users of the system, which may, for example, include one or more reminders about one or more upcoming appointments, educational information relating to the one or more users, and/or any other suitable information. In still other embodiments, the system may be configured to connect one or more people who may, for example, share one or more health related issues and facilitate communication between the one or more people (e.g., to enable the one or more people to provide support to one another, provide recommendations for lifestyles and work together to cope with the one or more health related issues, etc.).

In particular embodiments, the system is configured to provide: (1) a portal through which a user may retrieve important family medical and/or social data while also providing real-time medical alerts, (2) a communication portal between users and healthcare practitioners, and/or (3) a link between patients and medical care providers. In various embodiments, the system is configured to provide a unified mobile application for providing one or more users with secure medical information, while also providing additional information and/or activities for keeping the one or more users engaged with the application.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

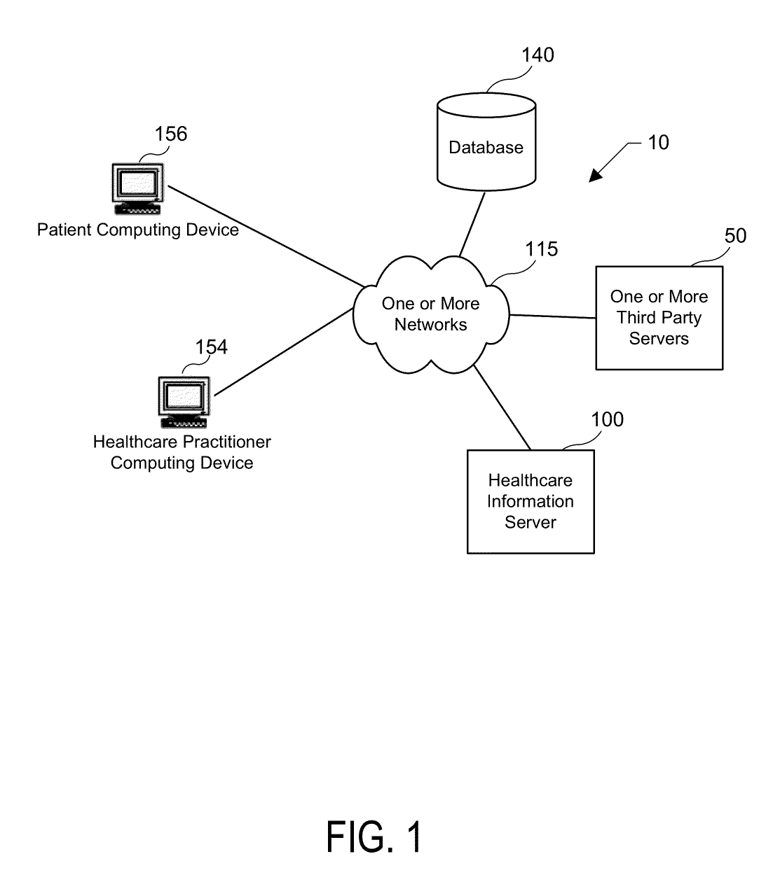

FIG. 1 is a block diagram of a System 10 according to a particular embodiment. As may be understood from this figure, the System 10 includes one or more computer networks 115, One or More Third Party Servers 50, a Healthcare Information Server 100, a Database 140, and one or more remote computing devices such as a patient computing device 156 (e.g., such as a smart phone, a tablet computer, a wearable computing device, a laptop computer, etc.) or a healthcare practitioner computing device 154 (e.g., such as a desktop computer or other computing device). In particular embodiments, the one or more computer networks facilitate communication between the One or More Third Party Servers 50, Healthcare Information Server 100, Database 140, and one or more remote computing devices 152, 154.

The one or more computer networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between System Information Server 100 and Database 140 may be, for example, implemented via a Local Area Network (LAN) or via the Internet.

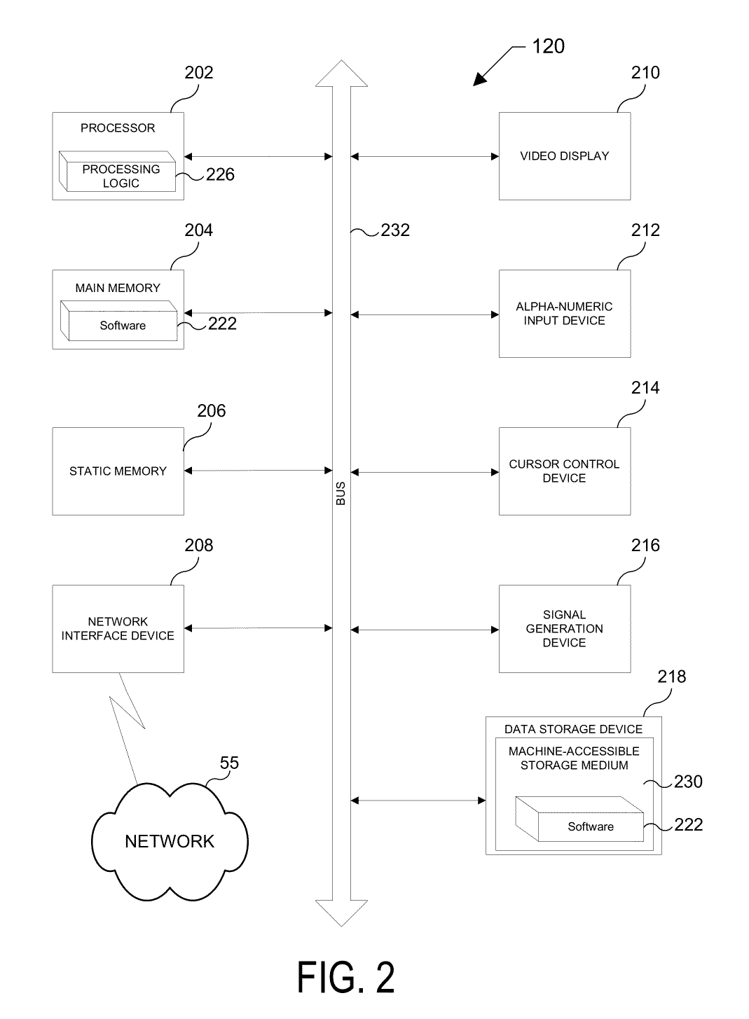

FIG. 2 illustrates a diagrammatic representation of a computer architecture 120 that can be used within the System 10, for example, as a client computer (e.g., one of computing devices 154, 156 shown in FIG. 1), or as a server computer (e.g., System Information Server 100 shown in FIG. 1). In particular embodiments, the computer 120 may be suitable for use as a computer within the context of the System 10 that is configured for providing access to medical information and providing communication between users and healthcare practitioners.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processing device 202 during execution thereof by the computer 120—the main memory 204 and the processing device 202 also constituting computer-accessible storage media. The software 222 may further be transmitted or received over a network 115 via a network interface device 208.

While the computer-accessible storage medium 230 is shown in an exemplary embodiment to be a single medium, the terms “computer-accessible storage medium” or “computer-readable medium” should be understood to include a single medium or multiple media (e.g., a centralized or distributed database, and/or associated caches and servers) that store the one or more sets of instructions. The terms “computer-accessible storage medium” and “computer-readable medium” should also be understood to include any medium that is capable of storing, encoding or carrying a set of instructions for execution by the computer and that cause the computer to perform any one or more of the methodologies of the present invention. The terms “computer-accessible storage medium” and “computer-readable medium” should accordingly be understood to include, but not be limited to, solid-state memories, optical and magnetic media, etc.

### Exemplary System Platform

Various embodiments of a healthcare information system may be implemented within the context of any suitable system information service. In particular embodiments, the system may be implemented as part of an application for accessing medical and other data for one or more people in a particular group (e.g., such as a family). In particular embodiments, the system may be provided by a medical facility, insurance carrier, or other suitable provider of medical information and/or care. In particular embodiments, the system is embodied as a unified software application (e.g., an app for a mobile computing device) from which the user can retrieve secure healthcare information, consumer information, family information, news, or other suitable information. In other embodiments, the system further includes a healthcare practitioner dashboard for enabling a healthcare practitioner to create one or more rules from which the system is configured to create one or more notifications (e.g., push notifications) for one or more users of the system. Various aspects of the system's functionality may be executed by certain system modules, including a Healthcare Information Module 300, which may, for example, be executed by a software application running on a mobile computing device (e.g., a cellular phone or tablet computer) or other computing device. This module is discussed in greater detail below.

Healthcare Information Module

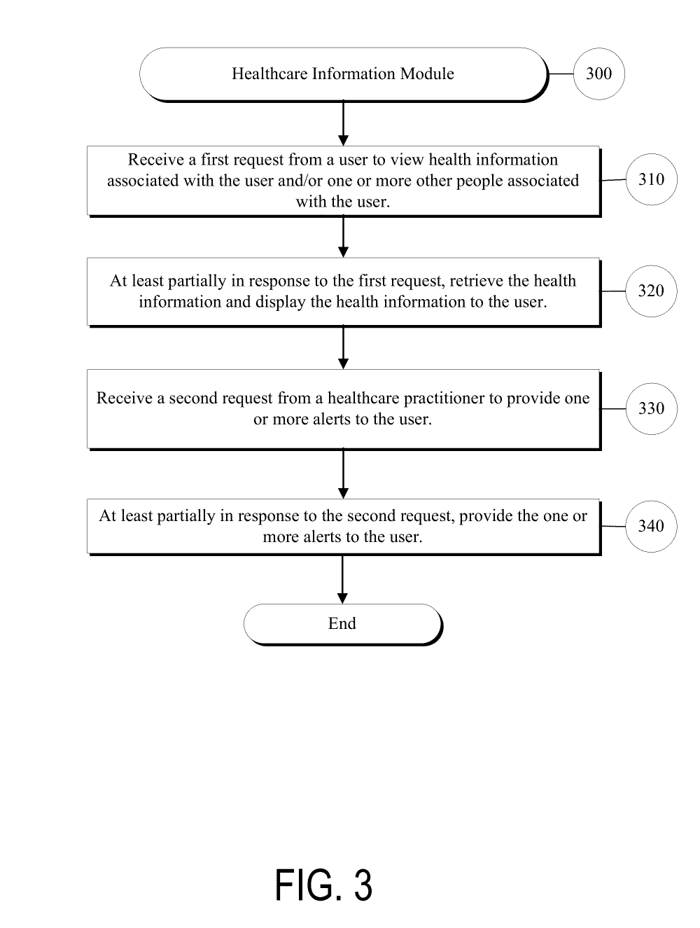

FIG. 3 is a flow chart of operations performed by an exemplary Healthcare Information Module 300. In particular embodiments, the Healthcare Information Module 300 may facilitate collecting, tracking, and/or storing healthcare information associated with one or more patients (e.g., one or more related patients) that includes, for example, medical records, appointment information, medication information, prescription information, and/or any other suitable medical information. In various embodiments, the Healthcare Information Module 300 is executed as part of a software application stored locally on a computing device (e.g., a mobile computing device).

When executing the Healthcare Information Module 300, the system begins, at Step 310, by receiving a first request from a user to view health information associated with the user and/or associated with one or more other people associated with the user. The user may, for example, be the head of a household (e.g., of a particular family) that is requesting health information for his or her self and/or one or more other members of the household. In particular embodiments, the user is a user having a medical power of attorney over the one or more other people associated with the user. In various embodiments, the user is a legal guardian or relative of the one or more other people associated with the user. In still other embodiments, the user is any user who may have a suitable need, or suitable legal standing to view the health information associated with the one or more other people (e.g., a social worker, guardian ad litem, etc.).

In particular embodiments, the requested health information may include any health information associated with the user and/or with the one or more other people associated with the user. In various embodiments, the health information may include, for example, medical history information, one or more medical records, one or more medical images (e.g., MRI, x-ray, CAT Scan, etc.), one or more medical test results, allergy information, information about one or more drugs prescribed to the user or the one or more other people, information about one or more upcoming medical appointments (e.g., a time, location, doctor, appointment type, pre-appointment instructions, etc.). In various embodiments, the health information may include health information associated with one or more relatives associated with the user or the one or more other people (e.g., a family medical history including a propensity toward particular medical issues, etc.).

In various embodiments, the system is configured to store the health information in a suitable data store (e.g., one or more suitable servers). In particular embodiments, the system is configured to receive the health information for storage from any suitable source, such as, for example, from a suitable health care professional, from a suitable health care patient, etc.

In particular embodiments, the system is configured to receive the request in response to a request made by the user via a computing device (e.g., a mobile computing device), via a suitable software application, or in any other suitable manner. The system continues, at Step 320, by, at least partially in response to the first request, retrieving the health information and displaying the health information to the user. In particular embodiments, the system is configured to display the health information on a display associated with a computing device (e.g., a mobile computing device) such as, for example, the computing device from which the user requested the health care information. In various embodiments, the system is configured to retrieve the health information from any suitable source.

The system continues, at Step 330, by receiving a second request from a healthcare practitioner to provide one or more alerts to the user. In particular embodiments, the healthcare practitioner may include a doctor, physician, nurse, pharmacist, and/or other practitioner who may be treating the user or the one or more people associated with the user. In various embodiments, the healthcare practitioner may have previously treated the user (e.g., and/or the one or more people associated with the user), may be currently treating them, or may be scheduled to treat them in the future (e.g., may have a future appointment with them). In other embodiments, the healthcare practitioner may include any other suitable person that may desire to (or be instructed to) send the one or more alerts to the user (e.g., such as a physician's assistant, insurance adjuster, or any other suitable person).

In particular embodiments, the one or more alerts may include any suitable alert related to the user's health and/or the one or more other people associated with the user's health. For example, the one or more alerts may include a reminder about one or more upcoming medical appointments, a reminder to schedule one or more upcoming medical appointments, an alert related to one or more medications taken by the user or the one or more persons associated with the user, a reminder to refill one or more prescriptions, educational or other information that may be useful to the user (e.g., about a condition from which the user suffers, about one or more new side effects associated with one or more medications taken by the user, etc.), information about a discount on one or more medications the user may be taken, or any other suitable one or more alerts (e.g., such as a follow up to an appointment, etc.).

In various embodiments, the system is configured to enable the healthcare practitioner to create one or more rules associated with the one or more alerts. The system may then be configured to determine which of the system's users fall under the one or more rules and, in response to determining that one or more users fall under the one or more rules, substantially automatically directing a push notification (e.g., containing the one or more alerts) to those one or more users. For example, a healthcare practitioner may create an alert containing information about flu vaccine side effects and create an associated rule to send a push notification to users of the system that have recently received a flu vaccination. The system may be configured to determine which users of the system have recently received a flu vaccination and send a notification to those users containing the side effects.

In various embodiments, the system may be configured to determine which of the one or more users of the system fall under the one or more rules created by the healthcare practitioner based at least in part on profile information associated with the one or more users. The profile information may include information such as age, gender, occupation, weight, medical history, primary care physician, etc.

In various embodiments, the system may be configured to substantially automatically generate one or more alerts for a particular user. For example, the system may substantially automatically generate one or more alerts at least partially in response to determining that a user has recently undergone a particular medical procedure, that the user has reached an age where a particular procedure or checkup would be recommended, or for any other suitable reason.

The system continues, at Step 340, by, at least partially in response to the second request, providing the one or more alerts to the user. The system may provide the one or more alerts in any suitable manner, such as, for example, via a suitable computing device, via a software application, or in any other suitable manner.

### Additional/Alternative System Features

In particular embodiments, the healthcare information system may include features in addition to the features discussed immediately above. These additional features are discussed below.

Bi-Directional Messaging

In particular embodiments, the system is configured to enable the user to communicate with one or more healthcare practitioners using the system. In various embodiments, the system is configured to enable the user to send one or more messages in response to the one or more alerts provided by the healthcare practitioner. In other embodiments, the system is configured to enable the user to message a healthcare practitioner independently of an alert (e.g., to ask a question, etc.). In various embodiments, messages may include one or more standardized messages (e.g., messages selected from a drop down menu, such as frequently asked questions). In other embodiments, the messages may include one or more customized messages provided by the user and/or the healthcare practitioner. For example, the system may be configured to enable the user to send and receive messages to a healthcare practitioner via a software application, and the healthcare practitioner may send and receive messages via the healthcare practitioner dashboard.

Patient Connectivity

In various embodiments, the system is configured to enable users to connect with other users who may, for example, have similar medical conditions or medical issues. In such embodiments, users may be able to connect with others who may be in a similar situation to share tips, stories, encouragement, and/or other suitable information with one another. In particular embodiments, the system is configured to enable a user to opt in to a patient connection program. In some embodiments, the system is configured to enable the user to opt in to the patient connection program for one or more particular ailments (e.g., particular types of cancer, asthma, etc.). The system may, for example: (1) receive a request from a first user to connect with one or more other users who share at least one medical condition; (2) at least partially in response to receiving the request, determine at least one second user that shares the at least one medical condition; and (3) at least partially in response to determining the at least one second user, enabling the first and at least one second user to connect with one other. In various embodiments, enabling the first and at least one second user to connect with one another may include enabling the first and at least one second user to send one or more messages to one another. In particular embodiments, the users may provide information about dietary recommendations for dealing with the at least one medical condition, provide support in dealing with the at least one medical condition, etc.

In various embodiments, the system is configured to determine the at least one second user based at least in part on: (1) an age of the first user and the at least one second user; (2) a gender of the first user and the at least one second user; (3) a location of the first user and the at least one second user; etc. The system may, for example, determine the at least one second user such that the first user and second user are somewhat similar in age (e.g., within a few years of each other), are the same gender, etc. In some embodiments, determining at least one second user with similar medical conditions and of a similar age, etc. may enable the system to connect users that are in a good position to help one another based on their common current or past experiences with a particular medical condition.

As a particular example, the system may connect two user that suffer from psoriasis. The system may then enable the users to communicate regarding particular topical ointments that have proved useful in managing and treating breakouts of psoriasis, dietary restrictions that have limited breakouts, etc. In other embodiments, the system may enable the users to provide support in coping with psoriasis (e.g., social stigmas, etc.) and other issues which may result from having psoriasis such as, for example, depression, self-esteem issues, etc.

Document Safe

In particular embodiments, the system is configured to enable one or more users to capture and store one or more documents for later retrieval. These one or more documents may include, for example, birth certificates, government issued identification cards (e.g., passports, driver's licenses, etc.), social security cards, wills and other legal documents, or any other suitable document associated with the user or with the one or more people associated with the user. In particular embodiments, the documents may include health documents such as insurance information or other suitable health documents. In particular embodiments, the system is configured to provide a centralized database of important documents for retrieval by the user. In various embodiments, the system is configured to enable the user to capture the one or more documents using any suitable imaging device (e.g., a scanner, camera associated with a computing device, etc.).

Family Member Profiles

In particular embodiments, the system may include one or more profiles for the one or more people associated with the user. The one or more profiles may, for example, include one or more profiles for each member of the user's family. In particular embodiments, the one or more profiles may include a photo of each family member as well as information associated with the family member such as age, name, date of birth, gender, and/or any other suitable information discussed in this disclosure.

In particular embodiments, the system is configured to enable the user to create family member or other profiles (e.g., for each of their family members) and provide information associated with each profile (e.g., such as one or more profile photos, and other identifying information).

Journal

In particular embodiments, the system is configured to enable the user to create one or more journal entries associated with the user or associated with the one or more people associated with the user. In particular embodiments, the one or more journal entries may be associated with one or more particular life events such as, for example, birthdays, weddings, etc. In particular embodiments, the system is configured to enable the user to provide a description, date, one or more photos, etc. for the one or more journal entries. In various embodiments, the system is configured to enable the user to share the one or more journal entries on one or more social networks (e.g., Facebook, twitter, etc.).

Preferred Retailers

In various embodiments, the system is configured to enable the user to provide one or more names of one or more preferred retailers. In particular embodiments, the system is configured to provide discounts from the one or more retailers to the user (e.g., in the form of coupons, cash-back-rewards, etc.). In various embodiments, the one or more retailers may include retailers that sell items of a medical nature (e.g., medications, bandages, etc.). In other embodiments, the one or more retailers may sell any other suitable items or services.

Postcard Sharing

In various embodiments, the system is configured to enable a user to create and share one or more electronic postcards, which may for example, include text, one or more pictures, etc. The user may, for example, take one or more photographs using a suitable mobile device (e.g., smartphone) and use the system to digitally add text and/or one or more messages the one or more photographs. The user may then share the postcard with others, for example, as a text message, e-mail, or via a suitable social network (e.g., such as Facebook, twitter, etc.)

Health Tracking Applications

In various embodiments, the system is further configured to receive and track information associated with the health of the user. For example, the system may enable the user to input calorie data for food that the user consumes, exercise information for exercise that the user performs, etc. In particular embodiments, the system may comprise and/or be adapted to communicate with a pedometer that, for example, tracks the movement of the user throughout the day (e.g., GPS or an accelerometer via a mobile computing device of the user that the user carriers with them throughout the day such as a cell phone or other suitable mobile computing device).

Exemplary User Experience

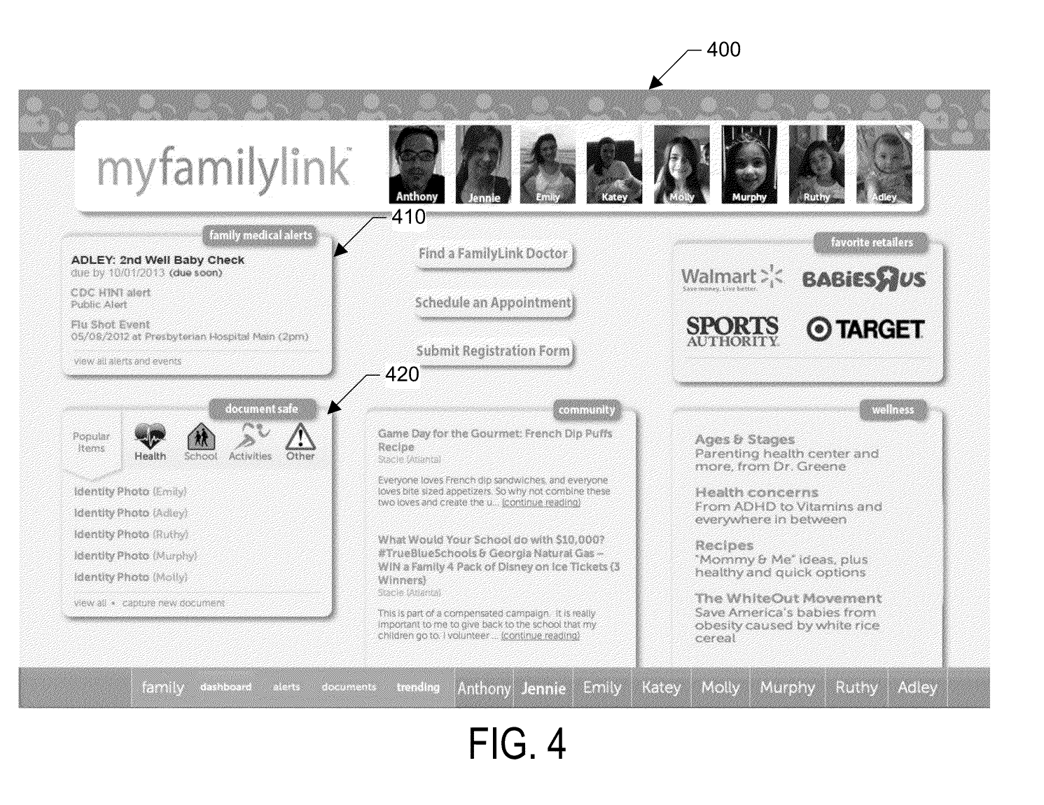

In a particular embodiments, a user may install a software application on their mobile computing device (e.g., on their smartphone). The user may access the system via the software application. FIGS. 4-12 are exemplary screen displays depicting various features of the system described herein. As should be understood, these screen displays may be displayed on any suitable device.

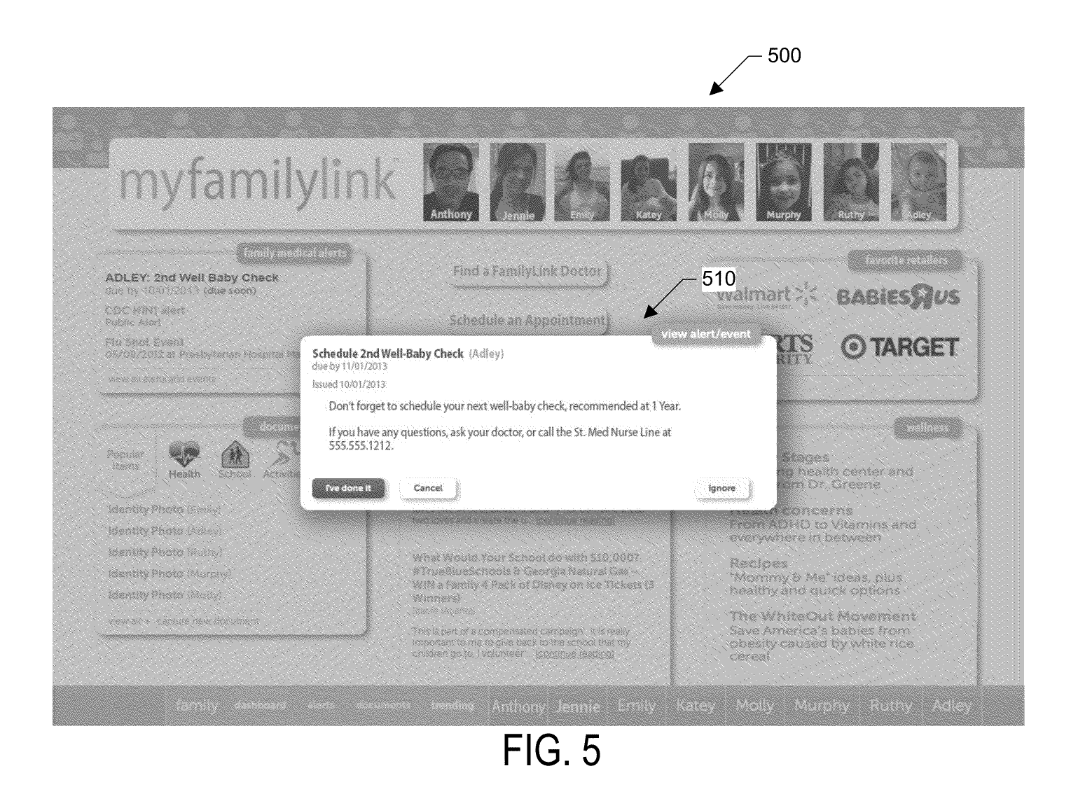

FIG. 4 depicts a screen display 400 showing an interface from which a user may access various medical information, alerts 410, documents 420, and other information. As shown in this figure, the interface, in this embodiment, includes photographs of family members as well as a dashboard form which a user can access various information, such as the information discussed in this disclosure. FIG. 5 depicts a screen display 500 showing an alert 510 provided to the user by the system. The alert may have been automatically generated by the system, for example, based on an age of the child for whom the alert applies. The alert includes additional information such as an instruction to contact a doctor or nursing hotline in case of questions from the user. The alert is further configured to enable the user to confirm that they have performed the action for which the alert was generated, or ignore the alert.

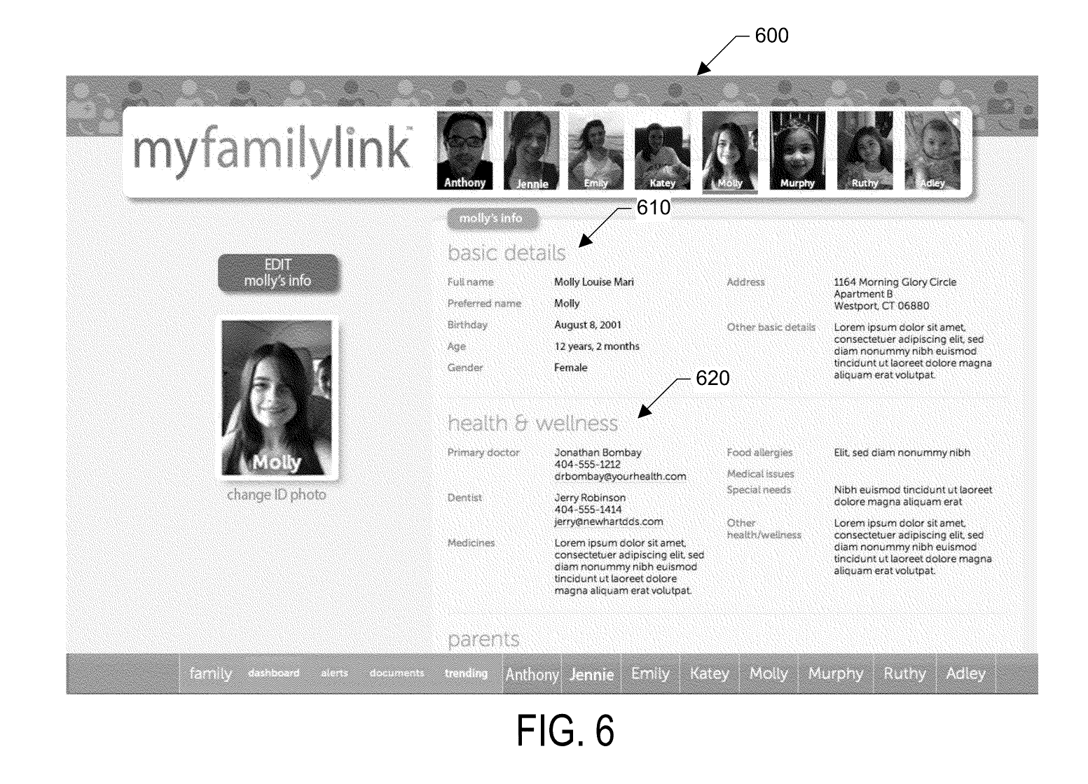

FIG. 6 depicts a screen display 600 showing a profile for a particular family member of the user. As shown in this figure, the screen display includes basic information 610 as well as health and wellness information 610 for the particular family member. In this embodiment, the basic information includes the family member's full name, preferred name, age, gender, address and other basic details. The health and wellness information includes the family member's primary doctor, dentist, medications, food allergies, medical issues, special needs, and other health/wellness information.

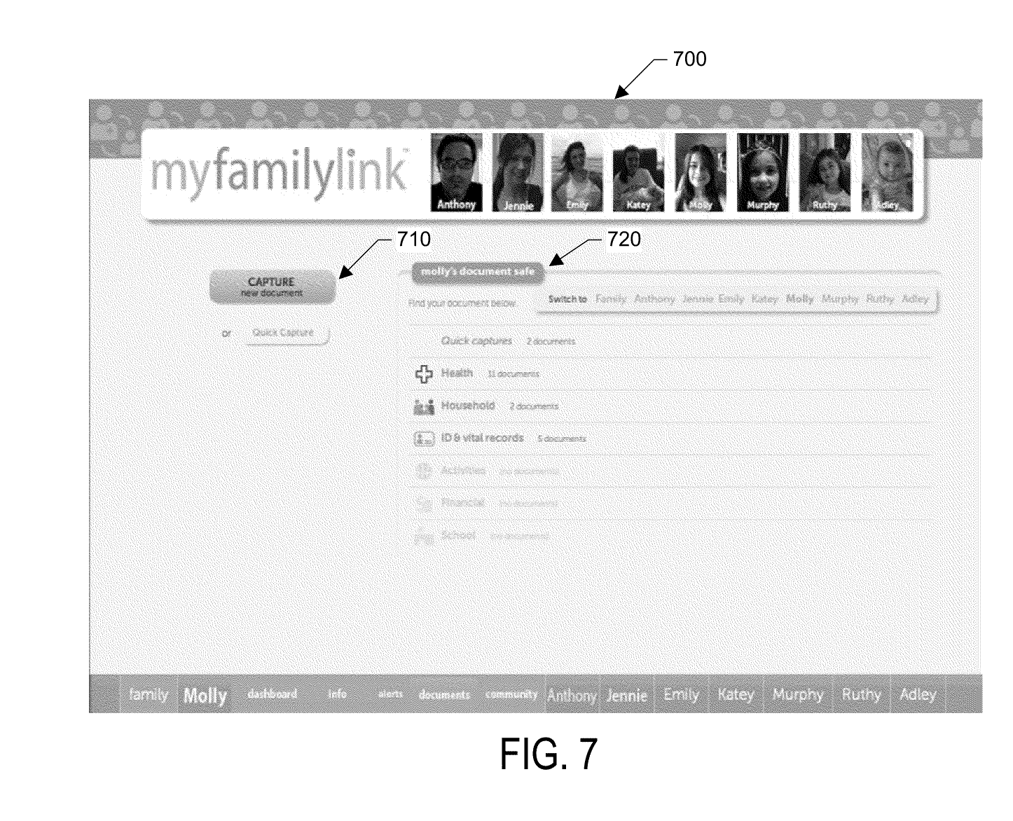

FIG. 7 depicts a screen display 700 having an interface for capture of documents. As shown in this figure, the screen display 700 includes an indicia 710, which a user may select to capture a new document for storage by the system. In various embodiments, the user may capture the document by selecting the indicia and selecting one or more files containing the one or more documents or taking an image of the one or more documents. The screen display 700 further includes documents stored by the system 720, which the user may access by selecting a particular category of document and then selecting one or more documents within the category (e.g., health documents, household documents, ID and vital records, etc.).

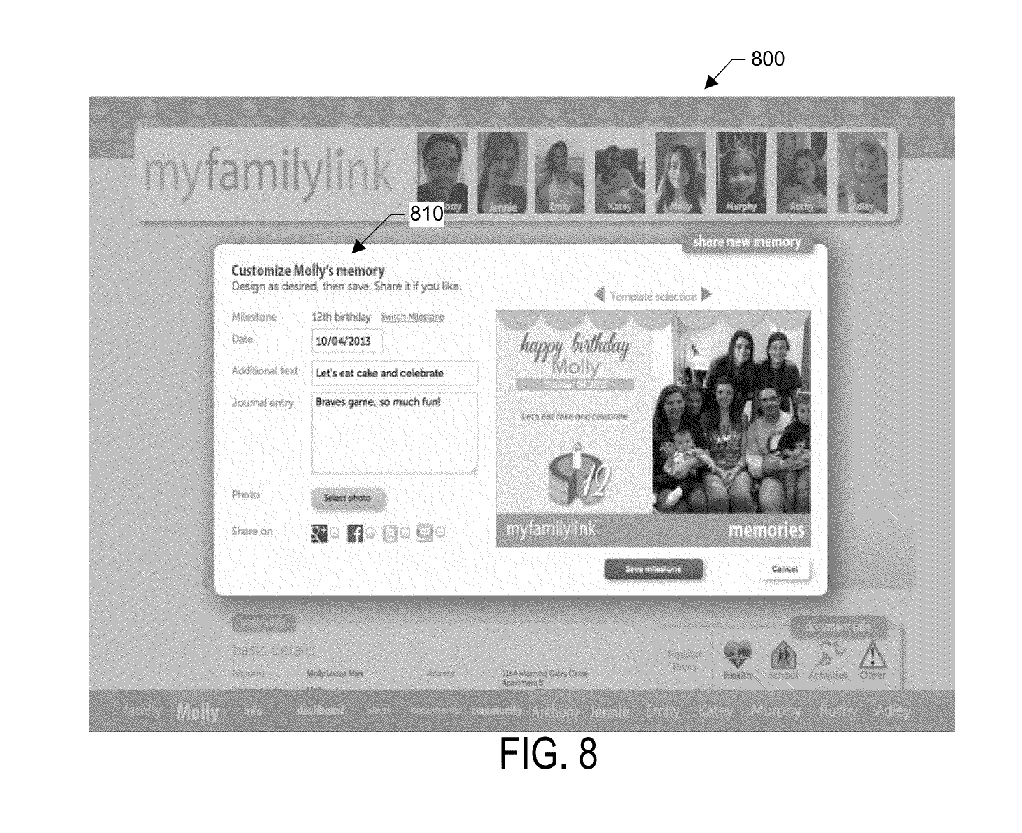

FIG. 8 depicts a screen display 800 having an interface 810 for creation, by the user, of one or more journal entries (e.g., memories) for association with one or more family members. The journal entry interface 810 may include any suitable interface and enable the user to provide details for the entry, such as any of the details discussed above.

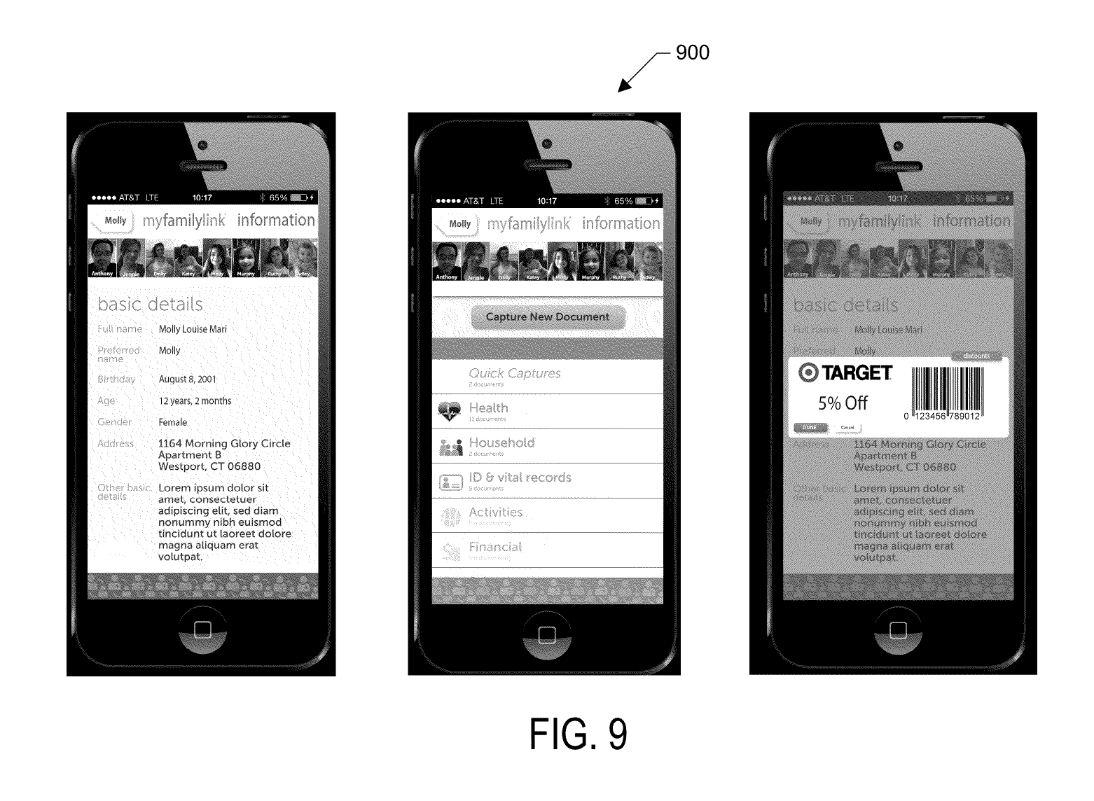

FIG. 9 depicts screen displays 900 according to particular embodiments, which a user may experience when accessing the system via a suitable mobile device. As may be understood from this figure, mobile screen displays may include information that is similar to screen displays configured for viewing on larger displays but in a more compact manner.

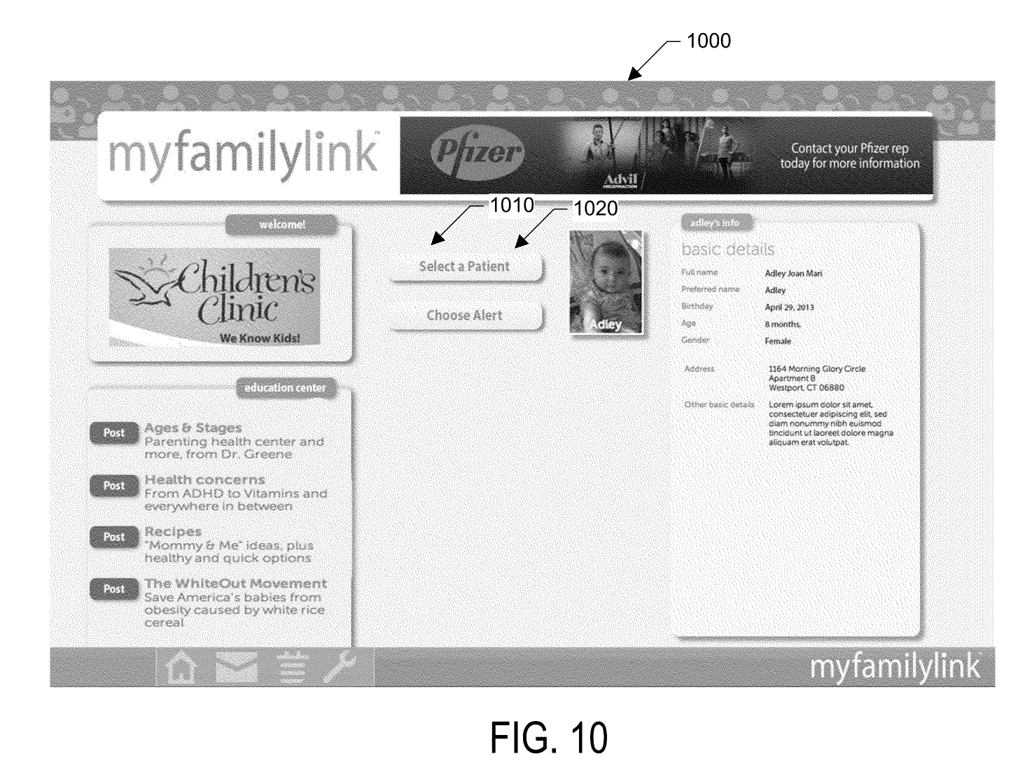

FIG. 10 depicts a screen display 1000 of an exemplary healthcare practitioner dashboard. As may be understood from this figure, a healthcare practitioner may utilize the healthcare practitioner dashboard to select one or more patients (e.g., by selecting a suitable indicia 1010 and selecting the patients from a suitable list of patients or typing in a patient's name), for sending one or more alerts (e.g., by selecting a suitable indicia 1020), or creating rules which a particular patient must fall under in order to receive a chosen alert.

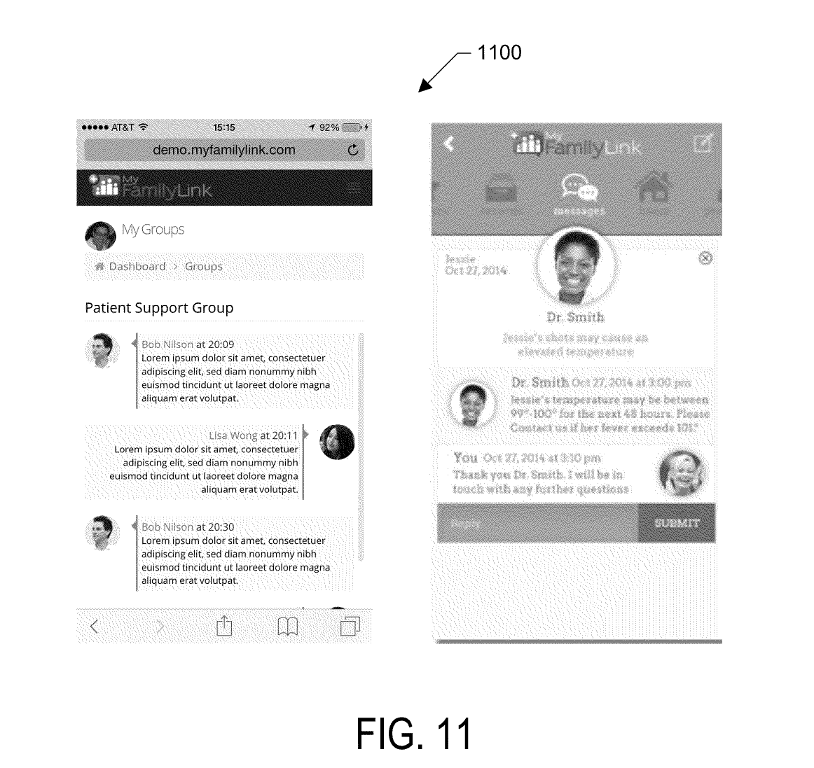

FIG. 11 depicts screen displays 1100 of the system according to various embodiments. As may be understood from these figures, user may use these interfaces to communicate (e.g., via two-way communication) with: (1) other users (e.g., other users that share one or more medical conditions); and (2) healthcare practitioners. In other users may communicate with any other suitable people.

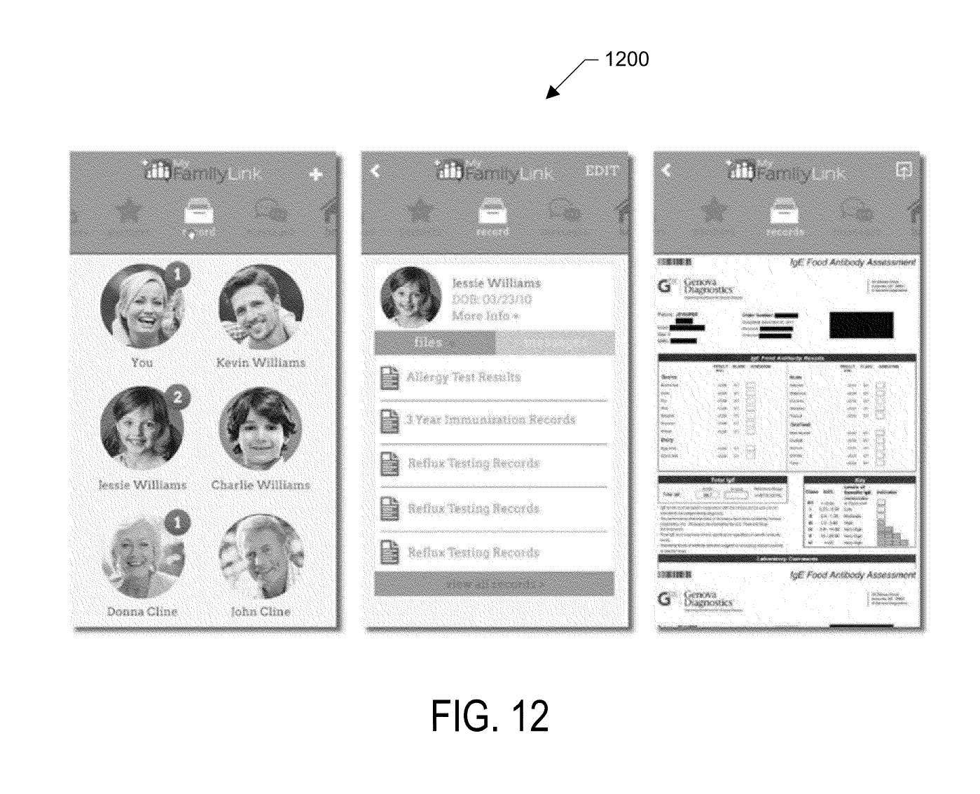

FIG. 12 depicts screen displays 1200 according to still other embodiments of the system. These screen displays depict yet another embodiment of a system form which a user may view medical information (e.g., medical documents) associated with other members of their family.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer-implemented method comprising:
providing, by a processor, to a user, a patient interface for enabling the user to access a unified healthcare information system;
receiving, by a processor, a first request, from the user via the patient interface, to view healthcare information associated with a person selected from a group consisting of:
(i) the user; and
(ii) one or more people associated with the user;
at least partially in response to receiving the first request, retrieving, by a processor, the health information and displaying the health information to the user;
providing, by a processor, to a healthcare practitioner, a healthcare practitioner dashboard for sending one or more alerts to the user;
receiving, by a processor, a second request from a healthcare practitioner via the healthcare practitioner dashboard to provide one or more alerts to the user based at least in part on one or more rules; and
at least partially in response to receiving the second request, determining, by a processor whether the user falls under the one or more rules; and
at least partially in response to determining that the user falls under the one or more rules, substantially automatically sending a push notification, by a processor, to the user that comprises the one or more alerts.

2. The computer-implemented method of claim 1, further comprising:
enabling, by a processor, two way communication between the user and the healthcare practitioner.

3. The computer-implemented method of claim 1, wherein the healthcare information comprises information selected from a group consisting of:
(i) one or more medical records; and
(ii) information associated with one or more medical appointments.

4. The computer-implemented method of claim 1, wherein the one or more people associated with the user are one or more members of a household of the user.

5. The computer-implemented method of claim 4, further comprising:
enabling, by a processor, the user to create one or more profiles for each of the one or more members of the household of the user.

6. The computer-implemented method of claim 1, wherein the one or more alerts comprise one or more reminders to schedule a medical appointment.

7. The computer-implemented method of claim 1, wherein the one or more alerts comprise educational information associated with the medical information of the user.

8. The computer-implemented method of claim 1, wherein the one or more alerts comprise a discount on a medication taken by the user.

9. The computer-implemented method of claim 1, further comprising:
receiving, from the user, a request to connect with at least one second user having at least one shared medical condition;
at least partially in response to receiving the request, determining the at least one second user; and
at least partially in response to determining the at least one second user, enabling two way communication between the user and the at least one second user.

10. A computer-implemented method of facilitating healthcare communication, the method comprising:
receiving, by a processor, a first request from a first user to view medical information associated with the first user, the medical information including medical information associated with at least one medical condition;
at least partially in response to receiving the first request, providing, by a processor, the medical information to the first user;
receiving, by a processor, a second request from the first user to connect with at least one person having at least one shared medical condition;
at least partially in response to receiving the second request, determining, by a processor, at least one second user having the at least one shared medical condition; and
at least partially in response to determining the at least one second user, enabling two way communication between the first user and the second user.

11. The computer-implemented method of claim 10, further comprising:
determining, based at least in part on the medical information associated with the first user, at least one medical alert; and
at least partially in response to determining the at least one medical alert, providing the at least one medical alert to the first user.

12. The computer-implemented method of claim 11, wherein the at least one medical alert comprises one or more reminders to schedule a medical appointment.

13. The computer-implemented method of claim 11, wherein the at least one medical alert comprises educational information associated with the medical information of the first user.

14. The computer-implemented method of claim 10, wherein determining the at least one second user comprises:
determining an age of the first user;
determining a gender of the first user; and
determining the at least one second user based at least in part on the age and the gender of the first user.

15. The computer-implemented method of claim 14, further comprising:
providing, by a processor, to a healthcare practitioner, a healthcare practitioner dashboard for sending one or more alerts to the first user;
receiving, by a processor, a third request from a healthcare practitioner via the healthcare practitioner dashboard to provide one or more alerts to the first user based at least in part on one or more rules;
at least partially in response to receiving the third request, determining, by a processor whether the first user falls under the one or more rules; and
at least partially in response to determining that the first user falls under the one or more rules, substantially automatically sending a push notification, by a processor, to the first user that comprises the one or more alerts.

16. The computer-implemented method of claim 15, further comprising:
enabling, by a processor, two way communication between the first user and the healthcare practitioner.

17. The computer-implemented method of claim 16, wherein the healthcare information is selected from a group consisting of:
(i) one or more medical records; and
(ii) information associated with one or more medical appointments

18. A non-transitory computer-readable medium storing computer executable instructions for:
providing a patient interface for enabling the user to access a unified healthcare information system to a first user;
providing a healthcare practitioner dashboard for sending one or more alerts to the first user to at least one healthcare practitioner;
providing a patient connection interface for connecting one or more patients to the first user;
receiving, from the first user via the patient interface, a first request to retrieve medical information associated with the first user;
at least partially in response to receiving the first request, displaying the medical information to the first user;
receiving, from the at least one healthcare professional via the healthcare practitioner dashboard, a second request to send an alert to the first user;
at least partially in response to receiving the second request, sending the alert to the first user;
receiving, from the first user via the patient connection interface, a third request to connect the first user with at least one second user sharing at least one medical condition with the first user;
at least partially in response to receiving the third request, determining at least one second user who shares at least one medical condition with the first user; and
at least partially in response to determining the at least one second user, facilitating two way communication between the first user and the at least one second user.

19. The non-transitory computer-readable medium of claim 18, wherein determining the at least one second user who shares at least one medical condition with the first user comprises:
determining an age of the first user; and
determining the at least one second user who shared the at least one medical condition with the first user based at least in part on the age of the first user.

20. The non-transitory computer-readable medium of claim 18, further storing computer-executable instructions for enabling two way communication between the first user and the at least one healthcare practitioner.
